(19) United States
(12) Patent Application Publication
(10) Pub. No.: US 2026/0056016 A1
(43) Pub. Date: Feb. 26, 2026

(54) Sensor Device, Sensor System, Environmental Monitoring System, Method and Computer Program

(71) Applicant: Bayerische Motoren Werke Aktiengesellschaft, Muenchen (DE)

(72) Inventors: Peter BADER, Olching (DE); Philipp LUDWIG, Kranzberg (DE); Winfried ZEHTNER, Steinkirchen (DE)

(21) Appl. No.: 18/994,208

(22) PCT Filed: Jul. 24, 2023
(86) PCT No.: PCT/EP2023/070462

§ 371 Date: Jan. 14, 2025

(30) Foreign Application Priority Data
Jul. 25, 2022 (DE) 10 2022 118 587.7

(51) Int. Cl. G01C 17/00; G01D 11/30

(52) U.S. Cl. CPC G01C 17/00; G01D 11/30

(57) ABSTRACT

The present disclosure relates to a sensor device for monitoring an environment of the sensor device, comprising: a housing; one or more sensors for detecting sensor data relating to the environment; a communication interface for wirelessly communicating sensor information based on sensor data; and a control device for controlling the sensor device; wherein the sensor device has an energy storage device for operating the sensor device, the sensor device has a mounting portion on the housing, and wherein the mounting portion is designed to reversibly arrange the sensor device securely on the ground at, on and/or in an external foundation.

### BACKGROUND AND SUMMARY

The present disclosure relates to a sensor device for monitoring an environment of the sensor device. The disclosure further relates to a sensor system, to an environmental monitoring system, and to a method for operating an environmental monitoring system. Additionally or alternatively, a computer program is provided comprising commands which, upon the execution of the program by a computer, initiate the at least partial implementation of the method by the latter. Additionally or alternatively, a computer-readable medium is provided comprising commands which, upon the execution of commands by a computer, initiate the at least partial implementation of the method by the latter.

Sensor devices for monitoring the environment of sensor devices are known from the prior art. Monitoring of the environment can be executed, for example, in order to detect and characterize changing circumstances in the environment. Sensor devices of this type are employed for the monitoring of roads and the environment thereof. For example, in the environment of a road, the sensor device can detect persons, animals and/or obstacles which are located on and/or alongside the road.

In order to ensure the operation of the sensor device, the sensor device is supplied with electric current and is communicatively connected, for example to an external server, for the exchange of data. The supply of electric current and communicative connection for the exchange of data typically require an infrastructure, which comprises power lines and/or telecommunication lines.

EP 1709610 B1 discloses a traffic intersection apparatus for capturing individual vehicle data at traffic intersections and for transmitting data to a central station for storage and processing, which comprises the following: a traffic detection device for capturing individual vehicle data at an intersection; a network connection to a central station; wherein the traffic detection device is functionally configured to transmit traffic signal information and individual vehicle information to the central station; and wherein a data collection device in the central station establishes a time point for the capture of one or more images, and communicates a time schedule to an image capture system.

DE 10 2012 208 974 A1 discloses a method and a system. The method and system can determine the estimated location of a vehicle, can measure a location of an object relative to the vehicle by the employment of a sensor which is connected to the vehicle, and can determine an updated vehicle location by the employment of the measured relative object location, in conjunction with previously saved object locations. The estimated vehicle location can be determined by the employment of a system which differs from that which is connected to the sensor, for example a GPS system. The object location can be measured relatively to a regional map which corresponds to the location of the vehicle.

However, the prior art requires an infrastructure, in order to permit the connection of the sensor device. The production and installation of this infrastructure can be labor-and cost-intensive, particularly in remote locations, on test routes and/or on works premises. Moreover, known sensor devices are associated with a specific location and, in consequence, cannot be employed in a locationally flexible manner, for example in a needs-based arrangement.

In the context of this prior art, an object of the present invention, in particular, is the disclosure of an improved sensor device which is appropriate for the enrichment of the prior art. A specific configuration of the present disclosure can fulfil this object, can provide an effective and flexibly employable sensor device, and can be operated for environmental monitoring.

This object is fulfilled by the features of the independent claim. Optional further developments of the disclosure are the subject matter of the dependent claims and sub-claims.

Accordingly, an object is fulfilled by a sensor device for monitoring an environment of the sensor device. The sensor device comprises a housing, one or more sensors for capturing sensor data relating to the environment, a communication interface for wirelessly communicating sensor information based upon the sensor data, and a control device for controlling the sensor device, wherein the sensor device comprises an energy storage device for operating the sensor device, the sensor device comprises a mounting portion on the housing, and wherein the mounting portion is designed to reversibly arrange the sensor device securely on the ground.

The sensor device is employed as a basis for the operation of sensors for monitoring the environment. Sensor data enable a characterization of the environment. Sensor data can be processed by the sensor device and/or by the control device into sensor information which, for example, assumes a smaller data volume than the sensor data, and can thus be appropriately transmitted via the communication interface. Via the communication interface, sensor information relating to the environment can then be wirelessly communicated to an external server and/or directly to a motor vehicle.

The sensor device comprises the energy storage device for operating the sensor device. The energy storage device is designed for storing energy, which is convertible into electrical energy, and for enabling the delivery thereof for the operation of the sensor device. The sensor device can thus be operated independently. With respect to the provision of electric current, the sensor device is thus independent of an electric power grid. The sensor device can be flexibly arranged at various locations, wherein a supply of electric current to the sensor device from an electric power grid is not required.

The mounting portion on the housing enables a reversible arrangement of the sensor device, securely on the ground. By the secure, and thus geostationary arrangement of the sensor on the ground, the sensor device can be positioned in a well-defined manner, in order to enable an accurate evaluation and/or interpretation of sensor data. The sensor device can be arranged such that the reliable capture of sensor data is enabled. In particular, a secure arrangement on the ground reduces any potential disturbance of sensors associated with movements of the sensor device. The reversible arrangement of the sensor device enables a non-destructive deployment and removal of the sensor device. The sensor device can thus be installed and removed in an efficient and cost-effective manner. In particular, the arrangement of the sensor device in various locations is thus enabled in a simple and effective manner.

The sensor device can comprise a charging interface for charging the energy storage device. The energy storage device is a rechargeable energy storage device. The charging interface is designed to supply electric current for charging the energy storage device, in order to enable the energization of the energy storage device with electric current. The charging interface can enable charging by means of an external current source and/or by a current source which is incorporated in the sensor device.

The sensor device can comprise a photovoltaic device which is connected to the charging interface. The photovoltaic device is designed to convert light into electrical energy and to supply energy for charging the energy storage device via the charging interface. Alternatively or additionally, the sensor device can comprise a wind energy device which is connected to the charging interface. Charging of the energy storage device at the site of use of the sensor device is enabled accordingly. The wind energy device is designed to convert the kinetic energy of an incident airstream to the wind energy device into electrical energy, and to execute the supply thereof for charging the energy storage device via the charging interface. Charging of the energy storage device at the site of use of the sensor device is thus enabled, even under poor light conditions. As a result of rechargeability by means of the photovoltaic device and/or the wind energy device, the sensor device can be operated independently.

The communication interface can be designed for communication with an external server. The sensor device can transmit sensor information to the external server via the communication interface. To this end, the communication interface can be designed to exchange data with the external server by the transmission and/or reception thereof via a cellular network and/or via a local network. An external, for example a central processing, further processing and/or relaying of sensor information is enabled accordingly.

The sensor device can comprise a positional sensor. The positional sensor is designed to capture a geolocation or coordinates of the sensor device. By means of the positional sensor, an automated capture of the position of the sensor device is enabled. Geolocation enables a localization of sensor data thus captured and/or of sensor information which is based thereupon in the environment of the sensor device. Any manual capture of position is unnecessary, thus enabling a more reliable interpretation of sensor information. Alternatively or additionally, the sensor device can comprise a compass. The compass is designed to capture an orientation or alignment of the sensor device. The compass enables an automated capture of the orientation of the sensor device. Orientation enables an accurate localization of sensor data thus captured and/or of sensor information based thereupon in the environment of the sensor device. Any manual capture of orientation is unnecessary, thus enabling a more reliable interpretation of sensor information.

The housing can comprise a service opening for servicing the sensor device. The service opening is designed to enable a servicing and/or replacement of one or more components of the sensor device. An effective operation of the sensor device is enabled accordingly, for example for the purposes of the upgrading, calibration, installation, removal and/or servicing of the sensor device.

The energy storage device can be interchanged via the service opening. The energy storage device is interchangeable accordingly. For example, the energy storage device can comprise an interface which is configured as a plug-in contact for this purpose, by means of which a reversible connection of the energy storage device with the sensor device, for example with the control device, is enabled. Any recharging at the location of the sensor device can be omitted accordingly.

The above-mentioned subject matter can be described in different terms, and related to a specific configuration, which is not described by way of limitation of the present disclosure, as follows: for autonomous applications, it can be necessary for sensors, for example LiDAR sensors, cameras, etc., and cellular technologies such as WLAN, 5G, etc. to be supplied with voltage in areas where there is no corresponding infrastructure for this purpose. An environmental model of the monitored area is then generated using data from these sensors. Similar systems for the monitoring of construction sites using cameras are known. A base unit is enclosed in photovoltaic panels, in order to ensure a supply of energy. However, these units are too large for the present application and, at close to 800 kg, are also too heavy. The sensor device proposed herein is light in weight, is only around 2 meters in height, and can be installed/removed by a single person. The sensor device also forms a stable foundation for LiDAR sensors, which are not permitted to undergo any oscillations during operation. The core concept is an autonomous sensor station, in which accumulators, charge regulators and cellular modules, WLAN, 5G, LTE and other electronics are accommodated in a large pipe, for example of diameter >200 mm, of CFK, GFK and/or aluminum construction. This pipe can then be installed, in a simple manner, by the embedding thereof in a specific concrete foundation and/or can be bolted thereto using ground anchors. An interchange or servicing of an accumulator is enabled, in a simple manner, via a large opening. Various sizes of sensor device are conceivable, in order to permit the supply of a varying number of sensors. The smallest unit is equipped with an exchangeable accumulator. In the case of other sizes, PV modules can be fitted using simple fastenings. On the grounds of this simple and rapid installation, and the foundation thus provided, a rapid changeover of locations is enabled. A monitoring of workshop areas, approach roads and, potentially, of test routes, can thus be planned. Full-area monitoring of a test site requires a hugely complex infrastructure, with associated voltage supply and network facilities, and a large number of various sensors, cameras and LiDAR sensors. By means of the sensor device, one or more regions can be monitored, and thus enabled for communication with vehicles (V2X). If the consideration of different routes is required, sensor devices can be simply repositioned, and the range of wireless communication adjusted. The installation of modules is universal, and thus offers further potential applications for networked electronics, in particular for V2X communication. As an extension of V2I, in environments with no V2A (Vehicle to Anywhere) infrastructure, a rapid and autonomous set-up of cellular modules is enabled by means of the sensor devices.

According to a further aspect of the disclosure, a sensor system is provided. The sensor system comprises the above-mentioned sensor device and a foundation, wherein the foundation is designed to reversibly arrange the sensor device securely on the ground, on and/or in the foundation. By means of these foundations, well-defined locations for the arrangement of sensor devices can be provided. Moreover, foundations can improve the capture of sensor data on the grounds that, by means of foundations, the alignment or orientation of the sensor device is definable, and mechanical oscillations and/or vibrations of the sensor device which, for example, might influence the capture of sensor data, are reduced.

The foundation can be embedded in concrete in a subsurface and/or bolted therein by means of a ground anchor. A particularly effective and reliable arrangement of the foundation is thus enabled wherein, in particular, a stable mechanical connection between the foundation and a subsurface is provided.

The foundation can be designed, in the installed state, to provide a predetermined orientation of the sensor device. A compass for the sensor device can thus be dispensable. Orientation enables an accurate localization of sensor data thus captured and/or of sensor information based thereupon in the environment of the sensor device. Any manual capture of orientation is unnecessary, thus enabling a more reliable interpretation of sensor information.

According to a further aspect of the disclosure, an environmental monitoring system is provided. The environmental monitoring system comprises the above-mentioned sensor system, and an external server having a communication module, wherein the server is connectable to the sensor system by means of the communication interface and the communication module, for the wireless transmission of data. The sensor device system can thus process sensor data thus captured into sensor information and/or can execute the transmission thereof to the external server in the form of sensor information. The external server can execute a further processing of sensor information thus received, in order to evaluate the sensor information, and thus to characterize the environment of the sensor device. The external server can thus assume a central function for the environmental monitoring system, in particular by the reception and processing of sensor information which is communicated by various sensor systems.

The server can be designed for wirelessly communicating environmental information relating to the environment to a motor vehicle. Sensor information received can be evaluated, in order to generate environmental information. Environmental information can characterize the environment, for example, independently of the format of sensor data captured and/or of the type of capture of sensor data. For example, environmental information can indicate whether a pedestrian, an animal, an obstacle and/or a hazard is present in the environment. Environmental information can be communicated to the motor vehicle, in order to generate a warning output and/or to execute an automated driving function.

According to a further aspect of the disclosure, a method is provided for operating the above-mentioned environmental monitoring system. The method comprises the following: communication of sensor information from the sensor system to the external server; evaluation of sensor information, for the determination of environmental information by the external server, and communication of environmental information from the server to a motor vehicle. An effective monitoring of the environment is thus enabled, wherein results of the monitoring of the environment are communicated to the motor vehicle in the form of environmental information.

The preceding subject matter described with reference to the sensor device, the sensor system and the environmental monitoring system also applies, in an analogous manner, to the method, and vice versa.

A computer program is further provided, comprising commands which, upon the execution of the program by a computer, initiate the at least partial implementation or execution by the latter of the above-mentioned method.

A program code of the computer program can be present in the form of an arbitrary code, in particular a code which is appropriate for the control device of the sensor device and/or for the external server.

The preceding subject matter described with reference to the sensor device, the sensor system, the environmental monitoring system and the method also apply, in an analogous manner, to the computer program, and vice versa.

A computer-readable medium, in particular a computer-readable storage medium, is further provided. The computer-readable medium comprises commands which, upon the execution of the program by a computer, initiates the at least partial implementation by the latter of the above-mentioned method.

This means that a computer-readable medium can be provided, which comprises an above-mentioned computer program. The computer-readable medium can be an arbitrary digital data storage device such as, for example, a USB stick, a hard disk, a CD-ROM, a SD card or a SSD card. The computer program is not necessarily saved on a computer-readable storage medium of this type, but can also be sourced from the internet or otherwise obtained from an external source.

The preceding subject matter described with reference to the sensor device, the sensor system, the environmental monitoring system, the method and the computer program also applies, in an analogous manner, to the computer-readable medium, and vice versa.

### BRIEF DESCRIPTION OF THE DRAWINGS

One embodiment is described hereinafter with reference to FIGS. 1 and 2.

FIG. 1 shows a schematic representation of a sensor device, a sensor system and an environmental monitoring system, each according to one aspect of the disclosure, and a motor vehicle; and

FIG. 2 shows a schematic representation of a sequence of a method according to one aspect of the disclosure.

### DETAILED DESCRIPTION OF THE DRAWINGS

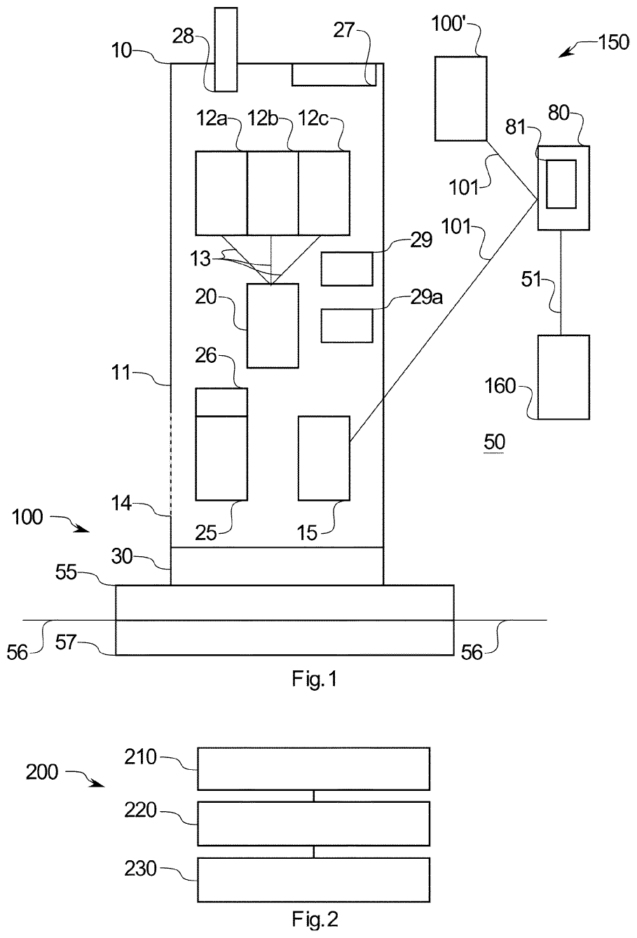

FIG. 1 shows a schematic representation of a sensor device 10, a sensor system 100, 100′ and an environmental monitoring system 150, each according to one aspect of the disclosure, and a motor vehicle 160.

The environmental monitoring system 150 comprises two sensor systems 100, 100′, and an external server 80 having a communication module 81. One of the sensor systems 100 is illustrated in detail. The other sensor system 100′ can be configured identically to the sensor system 100 which is illustrated in detail, and is only illustrated in less detail in the interests of simplicity. In another embodiment, the environmental monitoring system 150 can comprise one, or more than two sensor systems 100, 100′. The sensor system 100 which is illustrated in detail is described hereinafter.

The sensor system 100 according to FIG. 1 comprises a sensor device 10. The sensor device 10, and thus the sensor system 100, is arranged in an environment 50 of the sensor device or of the sensor system 100, in order to monitor the environment 50. In the environment 50, for example, an (unrepresented) road is located. The motor vehicle 160 is arranged in the environment 50, for example on the road. By the arrangement of multiple sensor systems 100, 100′, the environment 50 of the motor vehicle 160 can be comprehensively monitored. To this end, the environmental monitoring system 150, for example, can execute the method 200 described with reference to FIG. 2.

As shown in FIG. 1, the sensor device 10 comprises multiple sensors 12a, 12b, 12c for the capture of sensor data 13 relating to the environment 50. For example, the sensor device 10, by way of the sensors 12a, 12b, 12c, comprises a LiDAR sensor 12a, a camera device 12b and a radar sensor 12c. Each of the sensors 12a, 12b, 12c is designed to capture sensor data 13 which comprises information concerning the environment 50. Each of the sensors 12a, 12b, 12c can be designed to capture sensor data 13 which characterize a specific segment of the environment 50.

For example, the LiDAR sensor 12a can be designed to capture sensor data 13 which characterize the environment 50 within a distance of up to 300 m from the sensor device 10, and within a predetermined angle. The LiDAR sensor 12a can execute a full circumferential capture of the environment 50, i.e. through an angle of 360°. The LiDAR sensor 12a is designed to execute a time-of-flight measurement of a light beam which is emitted by the LiDAR sensor 12a, is reflected in the environment 50, and the reflection of which can be captured by the LiDAR sensor 12a. The LiDAR sensor 12a can thus capture distance or depth information.

The camera device 12b is designed to capture image data relating to the environment 50 within a specific field of capture. The camera device 12b can capture, for example, pixel graphics which comprise color information and/or monochrome information. To this end, the camera device 12b can comprise, for example, a CCD sensor.

For example, the radar sensor 12c can be designed to capture sensor data 13 which characterize the environment 50 within a distance of up to 100 m from the sensor device 10, and within a predetermined angle.

The sensors 12a, 12b, 12c are connected to a control device 20 which is incorporated in the sensor device 10. The control device 20 is designed for controlling the sensor device 10. To this end, the control device 20 comprises an unrepresented processor for data processing, and an unrepresented memory for saving data. For example, the control device 10 can execute the further processing of sensor data 13 in order to enable, for example, a machine learning-supported identification and/or classification of objects in the sensor data 13. By reference to the sensor data 13, the control device 10 ascertains sensor information 101 which, for example, assumes a smaller data volume than the sensor data 13. Sensor information 101 comprises, for example, information relating to objects in the environment 50 and, on the grounds of the data volume thereof, can be transmitted in an efficient manner.

The sensor device 10 comprises a housing 11. The housing 11 comprises an (unrepresented) cylindrical section. The housing 11 assumes a diameter in excess of 200 mm, in order to enable the accommodation of components of the sensor device 10. In the interests of the particular suitability of the housing 11 and the sensor device 10 for flexible employment in different locations, the housing 11 is formed of a lightweight material. To this end, the housing comprises, for example, aluminum, carbon fiber-reinforced plastic (CfK) and/or glass fiber-reinforced plastic (GfK). In order to enable the installation and/or removal of the housing 11, and thus of the sensor device 10, for example by one person only, and to simultaneously enable an effective arrangement of sensors 12a, 12b, 12c at an advantageous height for the capture of sensor data 13, the housing 11 assumes a height of approximately 2 m.

The housing 11 comprises a service opening 14, which is schematically represented by a broken line, for servicing the sensor device 10. The service opening 14 is arranged in an (unrepresented) shell surface of the housing 11. In another embodiment, alternatively or additionally, the service opening 14 can be arranged in an end face of the housing 11. The service opening 14 can be closed, for example, by means of an (unrepresented) cover. The service opening 14 can assume a diameter of 10 cm to 30 cm.

The sensor device 10 comprises an energy storage device 25 for operating the sensor device 10. The energy storage device 25 stores energy which is convertible into electrical energy, and supplies energy for operating the sensor device 10. For example, the energy storage device 25 comprises a secondary lithium-ion battery, which is comparatively light in weight and which delivers a comparatively high capacity.

In one embodiment, the energy storage device 25 is interchangeable via the service opening 14. To this end, the energy storage device 25, for example by means of an unrepresented plug-in connection, can be released from the remaining components of the sensor device 10 and replaced with another energy storage device 25.

Alternatively or additionally, the energy storage device 25 is optionally rechargeable. To this end, the sensor device 10 comprises a charging interface 26 for charging the energy storage device 25. The sensor device 10 comprises a photovoltaic device 27 which is connected to the charging interface 26, in order to convert a proportion of incident solar radiation which is received by the photovoltaic device 27 into electrical energy. To this end, the photovoltaic device 27 can be arranged externally to the housing 14, in an (unrepresented) dedicated cut-out of the housing 14, which cut-out is pre-determined for the photovoltaic device 27 and/or on an (unrepresented) rack which is arranged externally to the housing 14. The photovoltaic device 27 is arranged on an upper end face of the housing 14. Additionally or alternatively, the photovoltaic device 27 is arranged on an (unrepresented) shell surface of the housing 14. The sensor device 10 comprises a wind energy device 28 which is connected to the charging interface 26, in order to convert an incident airstream which is received by the wind energy device 28 into electrical energy. To this end, the wind energy device 28 is arranged partially externally to the housing 14.

The sensor device 10 comprises a mounting portion 30 which is arranged on the housing 11 and/or which is formed by the housing 11, wherein the mounting portion 30 is designed to reversibly arrange the sensor device 10 securely on the ground. The mounting portion 30 is designed such that the sensor device can be arranged on an external foundation 55. The mounting portion 30 is connectable to the foundation 55, for example by means of an (unrepresented) bayonet connection and/or screw connection. The mounting portion 30 can comprise, for example, an (unrepresented) lock for securing the sensor device 10. The sensor system 100 comprises the foundation 55. The foundation 55 is designed for the reversible arrangement of the sensor device 10 securely on the ground, on and/or in the foundation 55. The foundation 55 is embedded in concrete in a subsurface 56, and is bolted by means of a ground anchor 57. The foundation 55 is designed, in the installed state, to provide a predetermined orientation of the sensor device 10. To this end, the foundation 55 assumes a first-rate orientation. For example, the foundation 55 comprises a bayonet and/or screw connection which is oriented such that the installed sensor device 10 assumes a first-rate orientation. Charging of the energy storage device 25 by the photovoltaic device 27 and the interpretation of sensor information 101 can thus be improved.

The sensor device 10 comprises a communication interface 15 for the wireless communication of sensor information 101 which is based upon sensor data 13. The communication interface 15 is designed for wireless communication by means of a cellular network, for example by means of 4G (LTE) and/or 5G. Alternatively or additionally, the communication interface 15 is designed for communication via a wireless local network, for example by means of a WLAN protocol or via a WiFi interface. The communication interface 15 can be designed for traffic networking, in particular by means of vehicle-to-everything (V2X) communication. In particular, the communication interface 15 is designed for communication with an external server 80.

The external server 80 is connected to multiple sensor systems 100, 100′. The server 80 is wirelessly connected to the sensor system 100, 100′ by means of the communication interface 15 and the communication module 81, for data transmission. The communication module 81 is designed for wireless communication by means of a cellular network, for example by means of 4G (LTE) and/or 5G. Alternatively or additionally, the communication module 81 is designed for communication via a wireless local network, for example by means of a WLAN protocol or via a WiFi interface.

The sensor systems 100, 100′ respectively communicate sensor information 101 relating to the respective environment of the sensor systems 100, 100′ to the server 80. The server 80 comprises an unrepresented processor for data processing and an unrepresented memory for saving data. The server 80 can thus execute the further processing of sensor information 101 received. For example, the server 80 can merge sensor information 101 received from various sensor systems 100, 100′, in order to execute a comprehensive characterization of the environment 50. The effectively characterizable environment 50 can thus be arbitrarily expanded, and is not restricted to the capture range of one of the individual sensor systems 100, 100′. From the sensor information 101, the server 80 ascertains environmental information 51 relating to the environment 50, for example with respect to objects, obstacles and/or hazards in an environment and/or on a route of the motor vehicle 160.

By means of the communication module 81, the server 80 is designed to wirelessly communicate environmental information 51 to the motor vehicle 160. The motor vehicle 160 is designed to receive environmental information 51 and, optionally, to execute a further processing thereof, to output a message relating to the environmental information 51 and/or to execute an autonomous driving function.

The sensor device 10 comprises a positional sensor 29 and a compass 29a. The positional sensor 29 is a GPS sensor. The positional sensor 29 captures information relating to the positioning of the sensor device 10 and relays this information to the control device for the evaluation of sensor data 13 and/or, for the evaluation of sensor information 101, in combination with the sensor information 101, via the communication interface 15 to the server 80. The compass 29a captures information relating to an orientation of the sensor device 10 and relays this information to the control device for the evaluation of sensor data 13 and/or, for the evaluation of sensor information 101, in combination with the sensor information 101, via the communication interface 15 to the server 80.

FIG. 2 shows a schematic representation of a sequence of a method 200 according to one aspect of the disclosure. The method 200 is a method 200 for operating an environmental monitoring system 150. The environmental monitoring system 150 is described with reference to FIG. 1. The description of the method 200 according to FIG. 2 is provided in consideration of FIG. 1, and of the description thereof.

According to the method 200 represented in FIG. 2, a communication 210 of sensor information 101 is executed from the sensor system 100, 100′ to the external server 80. Different or mutually spaced sensor systems 100, 100′ can capture sensor data 13 relating to the environment 50 and correspondingly generate sensor information 101, and can execute the communication thereof to the server 80. The respective sensor information 101 relates to the environment 50 of the respective sensor system 100, 100′. The sensor system 100, 100′ can comprise correlations, i.e. overlapping or disjunctive capture ranges, within which sensor data 13 can be captured.

An evaluation 220 of sensor information 101 is executed by an external server 80 for ascertaining environmental information 51. On the server side, the sensor information 101 undergoes an evaluation and/or further processing. In particular, sensor information 101 received from various sensor systems 100, 100′ can be merged, in order to execute a comprehensive characterization of the environment 50.

A communication 230 of environmental information 51 is executed from the server 80 to a motor vehicle 160. This communication 230, for example, is executed periodically at a predetermined time interval and/or is triggered by a position of the motor vehicle 160. For example, this communication 230 can be executed if the motor vehicle 160 approaches the environment 50 and, in particular, approaches the capture range of one of the sensor systems 100, 100′.

### LIST OF REFERENCE NUMBERS

10 Sensor device
11 Housing
12a Sensor
12b Sensor
12c Sensor
13 Sensor data
14 Service opening
15 Communication interface
20 Control device
25 Energy storage device
26 Charging interface
27 Photovoltaic device
28 Wind energy device
29 Positional sensor
29a Compass
30 Mounting portion
50 Environment
51 Environmental information
55 Foundation
56 Subsurface
57 Ground anchor
80 Server
81 Communication module
100 Sensor system
100′ Sensor system
101 Sensor information
150 Environmental monitoring system
160 Motor vehicle

1-14. (canceled)

15. A sensor device for monitoring an environment of the sensor device, comprising:
a housing;
one or more sensors configured to capture sensor data relating to the environment;
a communication interface configured to wirelessly communicate sensor information based upon the sensor data; and
a control device configured to control the sensor device;
wherein:
the sensor device comprises an energy storage device configured to operate the sensor device; and
the sensor device comprises a mounting portion on the housing, where the mounting portion is configured to reversibly arrange the sensor device securely on the ground.

16. The sensor device according to claim 15, wherein the sensor device comprises a charging interface configured to charge the energy storage device.

17. The sensor device according to claim 16, wherein the sensor device comprises a photovoltaic device which is connected to at least one of the charging interface or a wind energy device.

18. The sensor device according to claim 15, wherein the communication interface is configured to communicate with an external server.

19. The sensor device according to claim 15, wherein the sensor device comprises at least one of a positional sensor or a compass.

20. The sensor device according to claim 15, wherein the housing comprises a service opening for servicing the sensor device.

21. The sensor device according to claim 15, wherein the energy storage device is interchangeable via the service opening.

22. A sensor system comprising a sensor device according to claim 15 and a foundation, wherein the foundation is configured to reversibly arrange the sensor device securely on at least one of the ground, on in the foundation or in the foundation.

23. The sensor system according to claim 22, wherein the foundation is at least one of embedded in concrete in a subsurface or bolted therein by means of a ground anchor.

24. The sensor system according to claim 22, wherein the foundation is configured to, in the installed state, provide a predetermined orientation of the sensor device.

25. An environmental monitoring system, comprising a sensor system according to claim 22, and an external server having a communication module, wherein the server is connectable to the sensor system by means of the communication interface and the communication module, for the wireless transmission of data.

26. The environmental monitoring system according to claim 25, wherein the server is configured to wirelessly communicate environmental information relating to the environment to a motor vehicle.

27. A method for operating an environmental monitoring system according to claim 25, wherein the method comprises:
communicating sensor information from the sensor system to the external server;
evaluating sensor information, for the determination of environmental information, by the external server; and
communicating environmental information from the server to a motor vehicle.

28. A computer-readable storage medium comprising commands which, upon the execution of the commands by a computer, initiate the method of claim 27.
